(19) United States
(12) Patent Application Publication
(10) Pub. No.: US 2018/0142803 A1
(43) Pub. Date: May 24, 2018

(54) VALVE, AND CONTROL METHOD

(71) Applicant: ARIANEGROUP SAS, Paris (FR)

(72) Inventors: Stephane Fernand Guy COLAS, Les Andelys (FR); Serge Daniel LE GONIDEC, Vernon (FR); Manuel KLEIN, Vernon (FR); Philippe NOMERANGE, Poissy (FR)

(73) Assignee: ARIANEGROUP SAS, Paris (FR)

(21) Appl. No.: 15/568,070

(22) PCT Filed: Apr. 22, 2016
(86) PCT No.: PCT/FR2016/050959

§ 371 Date: Oct. 20, 2017

(30) Foreign Application Priority Data
Apr. 23, 2015 (FR) 1553633

(51) Int. Cl. F16K 31/124; F16K 31/128

(52) U.S. Cl. CPC F16K 31/1245; F16K 31/128

(57) ABSTRACT

A field of pneumatically-actuated regulator valves, and more specifically a regulator valve for regulating a flow of gas from an upstream duct to a downstream duct. The regulator valve has a passage to enable the upstream duct to communicate with the downstream duct, a movable member arranged to vary a flow section of the passage, and an actuator with an internal chamber in communication with an exhaust duct and an admission duct to connect to the upstream duct, the actuator being arranged to move the movable member. For control purposes, the regulator valve has a control unit incorporating at least one state observer to estimate at least one pressure that exists in the internal chamber from a measured position of the movable member and from a measured upstream pressure, and from an opening value for at least one valve installed in the admission duct and/or the exhaust duct.

### BACKGROUND OF THE INVENTION

The present invention relates to a regulator valve and to a method for regulating a flow of gas from an upstream duct to a downstream duct, with an actuator suitable for being fed by the fluid coming from the upstream duct, in such a manner that a fluid having its flow regulated by a movable member that is moved by the actuator serves at the same time as a source of energy for actuating it.

In the state of the art, pneumatically-actuated regulator valves are known for regulating gas flow, the valve having an actuator fed via a branch connection to the gas having its flow regulated by the regulator valve. Nevertheless, those known regulator valves present the drawback of requiring upstream pressure to be stable, since fluctuations in upstream pressure can result in instability in their operation. Regulation with a simple feedback loop for taking account of the upstream pressure does not necessarily solve that problem since the internal pressure of the actuator need not correspond in linear manner to the upstream pressure. Nevertheless, it is not always possible to measure that internal pressure in the actuator directly, in particular since the overall size of a pressure sensor can be incompatible with the desired miniaturization for the actuator.

### OBJECT AND SUMMARY OF THE INVENTION

The present invention seeks to remedy those drawbacks. In particular, this description seeks to propose a regulator valve for regulating a gas flow from an upstream duct to a downstream duct that enables the pressure of the fluid in the upstream duct to be used for its own actuation, while nevertheless ensuring stable operation of the regulator valve even in the event of fluctuations in the upstream pressure, and to do so in compact manner.

In at least one embodiment, this object is achieved by the fact that the regulator valve comprises a passage suitable for bringing the upstream duct into communication with the downstream duct, a movable member arranged so as to vary a flow section of said passage by moving, an actuator with an internal chamber in communication with an exhaust duct and an admission duct suitable for being connected to the upstream duct and arranged in such a manner as to move said movable member according to a pressure in said internal chamber, and at least one valve installed in said admission duct or in said exhaust duct, also comprises an upstream pressure sensor suitable for being installed in the upstream duct, a sensor for sensing the position of the valve member, and a control unit connected to at least said upstream pressure sensor and said sensor for sensing the position of the valve member, and to the at least one valve installed in at least one of said admission duct and said exhaust duct, the control unit incorporating at least one state observer suitable for estimating at least one pressure that exists in said internal chamber from measurements of the position of the movable member and of the upstream pressure, and from an opening value for each valve installed in the admission duct or the exhaust duct.

The term “state observer” is used to cover an extension of a mathematical model of a dynamic system that is represented in the form of a state representation, making it possible to reconstruct the state of the dynamic system from the model and from measurements of other magnitudes when the state is not measurable directly. By virtue of being incorporated in the control unit, the control unit can estimate at least one pressure in the internal chamber of the actuator and take it into account for controlling each admission and/or exhaust valve so as to avoid instability in the operation of the regulator valve, even in the event of perceptible fluctuations in the upstream pressure.

The state observer may in particular be a state observer using an unscented Kalman filter algorithm, thus making it possible to respond in particularly effective manner to the non-linear nature of the dynamic system formed by the regulator valve. Nevertheless, other types of state observer could also be envisaged, in particular other non-linear state observers.

In order to better control the actuation of the movable member, the regulator valve may include an admission valve installed in said admission duct and an exhaust valve installed in said exhaust duct, in order to obtain better control over the internal pressure in the internal chamber and thus over the actuation of the movable member. Nevertheless, it is also possible to envisage installing only an admission valve in the admission duct, or only an exhaust valve in the exhaust duct, in order to simplify the regulator valve and its control.

In order to facilitate control, each valve installed in the admission circuit and/or the exhaust circuit may be electrically controlled, e.g. being piezoelectrically actuated.

In particular, the actuator may include a resilient member for opposing a resilient return force against the pressure in the internal chamber, e.g. resilient walls surrounding the internal chamber and forming a bellows.

The present description also provides a method of regulating a flow of gas from an upstream duct to a downstream duct with the above-mentioned regulator valve. The method obtains a measurement of the position of the movable member by using the position sensor, and a measurement of the pressure in the upstream duct by using the pressure sensor, together with an opening value for each valve installed in the admission duct or the exhaust duct of the actuators, and a force setpoint for the actuator; uses the state observer to estimate at least one pressure existing in the internal chamber from said measured position of the movable member and from said measured upstream feed pressure, and also from said opening value of each valve, uses the estimated pressure in the internal chamber to calculate a force estimated to be exerted by the actuator, and then a force error, which is the difference between the force estimated to be exerted by the actuator and the force setpoint for the actuator, and uses the force error to obtain a command for each valve installed in the admission duct or the exhaust duct of the actuator. Thus, the state observer makes it possible to implement at least one force feedback loop so as to avoid instabilities in the operation of the dynamic system formed by the regulator valve.

Said opening value for each valve may result from the command for that valve, or it may be measured by an appropriate sensor.

In order also to provide position feedback upstream from the force feedback, thereby reinforcing the dynamic stability of the operation of the regulator valve, the regulation method may further comprise obtaining a position setpoint for the movable member, and calculating a position error of the movable member, and wherein the force setpoint for the actuator is obtained from the position error of the movable member, e.g. obtained as a function of said position error by a proportional integral regulator with means for preventing runaway of the integral. By way of example, the position error of the movable member may be calculated as the difference between an estimated position of the movable member, e.g. as estimated by the state observer, and the position setpoint. Using the estimated position makes it possible in particular to eliminate the measurement noise of the position sensor in this position feedback. Nevertheless, it is also possible to envisage using the position of the movable member, as measured by means of a position sensor, rather than this estimated position. In addition, this position feedback may be implemented at a frequency that is lower than the frequency with which force feedback is implemented.

The command for each valve may in particular be obtained as a function of a mass setpoint for gas in the internal chamber, which is calculated on the basis of the force error. More specifically, the mass setpoint may be calculated as a function of a setpoint for pressure in said internal chamber, which setpoint is obtained from the force error, e.g. by means of a proportional integral regulator, in which case the mass setpoint may be calculated by applying the ideal gas equation to said pressure setpoint, using a volume of the internal chamber, e.g. as estimated by the state observer, and a gas temperature, e.g. a measured temperature of the gas in the upstream duct.

In order also to provide mass feedback downstream from the force feedback, so as to further reinforce the dynamic stability of the operation of the regulator valve, said mass setpoint may be compared with an estimated mass for gas in the internal chamber, e.g. as estimated by the state observer, in order to calculate a mass error, which is the difference between the mass setpoint and the estimated mass.

In order to obtain the command for each admission and/or exhaust valve, a setpoint for the difference between the admission flow rate and the exhaust flow rate may be obtained, by way of example, via a proportional regulator on the basis of the mass error, and the command for each valve installed in at least one of the admission duct and the exhaust duct may be calculated using the inverse of a non-linear function determining the difference between the admission flow rate and the exhaust flow rate on the basis of an opening value for each valve installed in the admission duct and/or the exhaust duct of the actuator.

The control unit of this regulator valve may in particular be in the form of a programmable digital regulator. Consequently, the present description also relates to a data medium containing a set of instructions suitable for being executed by a programmable digital regulator in order to implement the above-mentioned regulation method. In the present context, the term “data medium” should be understood as any data storage device that can be read by a computer system, and in particular by a processor such as a programmable electronic regulator. Such a data medium may in particular be a magnetic data storage device, such as a magnetic disk or tape, an optical data storage device, such as an optical disk, or an electronic data storage device, such as a volatile or non-volatile electronic memory. The present description thus also relates to this set of instructions as a computer program and as a software product.

### BRIEF DESCRIPTION OF THE DRAWINGS

The invention can be well understood and its advantages appear better on reading the following detailed description of embodiments given as non-limiting examples. The description refers to the accompanying drawings, in which:

FIG. 1 is a diagram of a pneumatically-actuated regulator valve in a first embodiment;

FIGS. 2A to 2D are diagrams showing the steps of an unscented Kalman filter algorithm;

FIG. 3 is a diagram showing a pneumatically-actuated regulator valve in a second embodiment; and

FIG. 4 is a diagram showing a pneumatically-actuated regulator valve in a third embodiment.

### DETAILED DESCRIPTION OF THE INVENTION

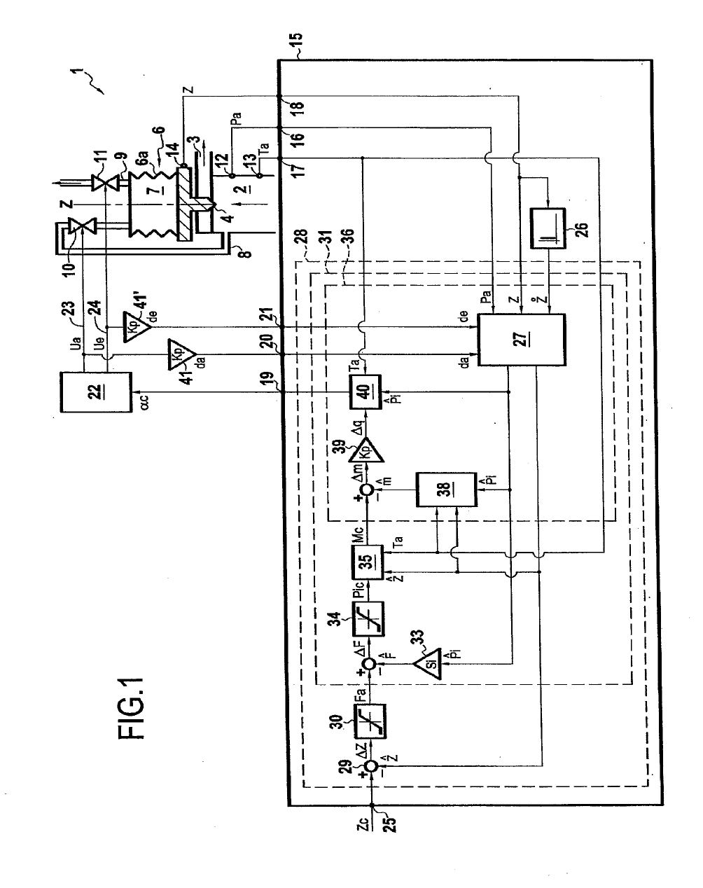

FIG. 1 shows a first embodiment of a regulator valve 1 for regulating a flow of gas from an upstream duct 2 to a downstream duct 3. The regulator valve 1 has a passage 4 connecting the upstream duct 2 to the downstream duct 3, and a movable member 5 arranged in such a manner, that, on moving, it varies a flow section for gas through the passage 4. In the embodiment shown, the passage 4 is formed by a circular orifice, and the movable member 5 has a conical tip 5a inserted in the circular orifice so as to vary its flow section in proportion to the axial movements of the movable member 5 along an axis Z perpendicular to the flow section. Nevertheless, other embodiments can be envisaged, with other shapes for the passage and/or the movable member, and also with different movements for the movable member 5 in order to vary the flow section for gas through the passage 4.

The regulator valve 1 is pneumatically actuated. It thus also includes an actuator 6 suitable for moving the movable member according to a gas pressure in an internal chamber 7 of the actuator 6. In the embodiment shown, the actuator 6 has resilient walls 6a forming a bellows around the internal chamber 7 and exerting a resilient return force on the actuator 6. Nevertheless, in other embodiments, the actuator 6 may take on other forms, with or without resilient return means.

An admission duct 8 connects the internal chamber 7 of the actuator 6 to the upstream duct 2. Thus, the actuator 6 may be energized by the upstream pressure pₐ of the same gas that is having its flow regulated. An exhaust duct 9 also connected to the internal chamber 7 of the actuator 6 serves to exhaust gas from the internal chamber 7 in order to reduce the internal pressure pᵢ therein.

In order to regulate the admission and the exhaust of gas into and from the internal chamber 7, the regulator valve 1 also has an admission valve 10 and an exhaust valve 11 installed respectively in the admission duct 8 and the exhaust duct 9. In the embodiment shown, these admission and exhaust valves 10 and 11 may in particular be electrically-controlled valves that are actuated piezoelectrically, each having a piezoelectric actuator and a bead arranged so as to be moved by the piezoelectric actuator so as to vary a flow section of the corresponding duct. Nevertheless, other types of valve, in particular electrically-controlled valves, could be envisaged as alternatives.

The regulator valve 1 also has an upstream pressure sensor 12, an upstream temperature sensor 13, and a sensor 14 for sensing the position of the movable member 5. The upstream pressure and temperature sensors 12 and 13 are arranged in the upstream duct 2 in such a manner as to obtain respective measurements of a pressure pₐ and a temperature Tₐ of the gas in the upstream duct 5, and the sensor 14 for sensing the position of the movable member 5 is arranged in such a manner as to obtain a measurement of the position z of the movable member 5.

In addition, the valve 1 has a control unit 15 that is in the form of a digital regulator in this example. The control unit 15 is connected to the sensors 12, 13, and 14 via corresponding inputs 16, 17, and 18 for receiving signals that correspond respectively to the measurements of the upstream pressure Pₐ, of the upstream temperature Tₐ, and of the position z of the movable member 5. It is also connected to the admission and exhaust valves 10 and 11 via an outlet 19 in order to transmit a shared-domain regulation signal α_{c} [alpha_c], and via two inputs 20 and 21 for receiving respective signals dₐ and dₑ corresponding to opening values respectively for the admission valve 10 and for the exhaust valve 11. A separator circuit 22 is interposed between the output 19 of the control unit 15 and the admission and exhaust valves 10, 11 and is configured to convert the shared-domain regulation signal α_{c} [alpha_c] into control signals uₐ and uₑ respectively for controlling the admission valve 10 and the exhaust valve 11, which signals are transmitted thereto via corresponding outputs 23, 24 of the separator circuit 10.

In the embodiment shown, this conversion applies the following equations:

uₐ=α_{c}·kᵤₘₐₓ

uₑ=(1−α_{c})·kᵤₘₐₓ

where kᵤₘₐₓ is a coefficient corresponding to a maximum value for the control signals uₐ, uₑ.

In the embodiment shown, the inputs 20, 21 of the control unit 15 are in fact connected to the respective outputs 23, 24 of the separator circuit 22 via proportional regulators 41, 41′ each having a gain kₚ that is appropriate for converting the respective control signals uₐ and uₑ into signals that represent the opening values dₐ and dₑ of the valves 10 and 11. Nevertheless, it is equally possible to envisage incorporating position sensors in the valves 10, 11 so that these opening values dₐ and dₑ are measured values rather than commanded values. Finally, the control unit 15 has an input 25 for receiving a position setpoint z_{c} for the movable member 5.

The control unit 15 has a differential regulator 26 that uses the signal corresponding to the measured position z of the movable member 5 to generate a signal corresponding to a speed measurement ż of the movable member 5. The control unit 15 also has a state observer 27 configured to estimate a state of the dynamic system formed by the regulator valve 1, this estimated state comprising in particular an estimated internal pressure \hat{p}ᵢ for the gas in the internal chamber 7 of the actuator and an estimated position \hat{z} for the movable member 5, on the basis of the measured position z and speed ż of the movable member 5, of the measured upstream pressure pₐ, and of the opening values dₐ, dₑ respectively of the admission valve 10 and of the exhaust valve 11. This state observer 27 is an “unscented” Kalman filter (UKF). This filter algorithm is described in “The unscented Kalman filter for non-linear estimation”, Proceedings of Symposium 2000 on Adaptive systems for signal processing, communication and control (AS-SPCC), IEEE, Lake Louise, Alberta, Canada, October 2000, can be used not only to filter signal noise, but even in predictive manner in order to predict the short-term variation of a non-linear dynamic system such as the regulator valve 1.

In such a dynamic system, it can be assumed that there exists a sequence of latent Markov states xₜ that vary over time in compliance with a model dynamic function F. These latent states are observed indirectly by the sensors giving measured states yₜ via a measurement function G. Thus, xₜ and yₜ may be expressed using the following formulas:

xₜ=F(xₜ₋₁)+ε

yₜ=G(xₜ)+ν

The values ε [epsilon] and ν [nu] represent respectively the noise inherent to the system and the measurement noise, and both of them have Gaussian distributions.

The purpose of a filter algorithm is to infer the state of the dynamic system from the noisy values measured by the sensors. A Kalman filter provides a fast and accurate inference for systems that are linear. Nevertheless, it is not directly applicable to systems that are non-linear, among which the present application might potentially be classified. Of various alternatives for adapting the Kalman filter algorithm to non-linear systems, one particular known filter is the “unscented” Kalman filter. That algorithm propagates a plurality of estimates of the latent state xₙ via the functions F and G and reconstructs a Gaussian distribution as if the propagated values were coming from a linear system. The positions of the estimates of the latent state xₙ are referred to as “sigma points”, and they are calculated from an initial average and variance using an approximation scheme referred to as an unscented transformation.

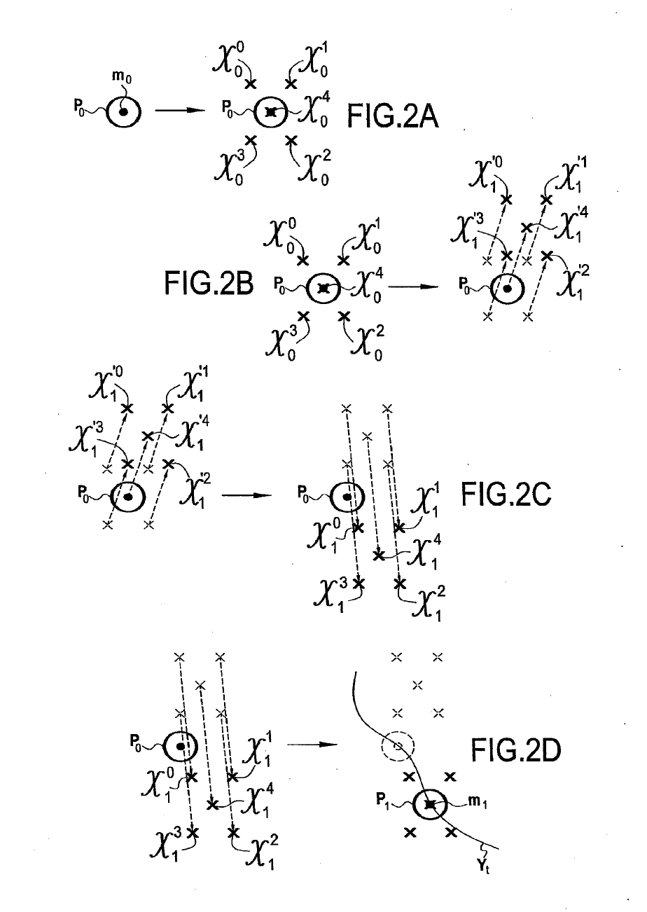

FIG. 2A shows a first step in which the initial sigma points X₀⁰, X₀¹, X₀², X₀³, X₀⁴ are calculated by such an unscented transformation from a average A₀ and a variance V₀ assuming for the latent state x₀ from a set of measurements y₀ corresponding to an initial sampling n=0. In the following step of prediction, as shown in FIG. 2B, estimated positions X′₀⁰, X′₀¹, X′₀², X′₀³, X′₀⁴ for the sigma points corresponding to the following sampling (n=1) are predicted by applying the prediction step of the Kalman filter algorithm to the initial sigma points X₀⁰, X₀¹, X₀², X₀³, X₀⁴. In the following step of updating, as shown in FIG. 2C, the actual sigma points X₁⁰, X₁¹, X₁², X₁³, X₁⁴ are calculated from this following sampling (n=1). The differences between the positions X′₀⁰, X′₀¹, X′₀², X′₀³, X′₀⁴ as predicted on the basis of the initial sigma points X₀⁰, X₀¹, X₀², X₀³, X₀⁴ and the positions X₁⁰, X₁¹, X₁², X₁³, X₁⁴ as actually calculated on the basis of the new sampling serves to obtain information about the function F for variation of the latent state xₙ over time. In the following step, as shown in FIG. 2D, a new average A₁ and a new variance V₁ are calculated on the basis of the new sigma points X₁⁰, X₁¹, X₁², X₁³, X₁⁴. This algorithm is recursive, and each step from the prediction step is repeated on each new sampling.

In the present example, the following equations are adopted for the model dynamic function F:

$${z}_{n} = \frac{1}{2 {m}_{p}} [ {p}_{{i}_{n - 1}} \cdot {S}_{i} - {p}_{{a}_{n - 1}} \cdot {S}_{c} + {K}_{a} ( \frac{{z}_{max}}{2} - {z}_{o} - {z}_{n - 1} ) ] Δ {t}^{2} + {z}_{n - 1}$$

$${\dot{z}}_{n} = \frac{1}{{m}_{p}} [ {p}_{{i}_{n - 1}} \cdot {S}_{i} - {p}_{{a}_{n - 1}} \cdot {S}_{c} + {K}_{a} ( \frac{{z}_{max}}{2} - {z}_{o} - {z}_{n - 1} ) ] Δ t + {\dot{z}}_{n - 1}$$

$${p}_{{i}_{n}} = \frac{γ}{{S}_{i} \cdot {z}_{n - 1}} [ \frac{R \cdot {T}_{a} \cdot {k}_{ae}}{{M}_{mol} \cdot {C}^{*}} ( {d}_{{a}_{n - 1}} \cdot {p}_{{a}_{n - 1}} - {d}_{{e}_{n - 1}} \cdot {p}_{{i}_{n - 1}} ) - {p}_{{i}_{n - 1}} \cdot {S}_{im} \cdot {\dot{z}}_{n} ] Δ t + {p}_{{i}_{n - 1}}$$

in which mₚ represents the movable mass of the pneumatic actuator 6 and of the movable member 5, Sᵢ represents the actuating surface area on which the internal pressure pᵢ in the chamber 7 of the pneumatic actuator 6 acts, S_{c} represents the surface area of the flow section through the passage 4, Kₐ is a coefficient associated with the actuator 6, zₘₐₓ is the amplitude of the maximum stroke of the actuator 6, zₒ is the length of the internal chamber 7 in the neutral position of the actuator 6, γ [gamma] is the quotient of the constant-pressure heat capacity of the gas divided by its constant-volume heat capacity, R is the universal constant of a perfect gas, Mₘₒₗ is the molar mass of the gas, kₐₑ is a characteristic coefficient common to the admission and exhaust valves 10 and 11, which are assumed in this example to be identical, C* is the characteristic speed of the gas, Sᵢₘ is the average cross-section of the internal chamber 7 of the actuator 6 (which in a bellows actuator may be less than the actuation surface area Sᵢ), and Δt is the time interval between two successive samplings. These equations thus serve to provide predicted values for the position z and for the speed ż of the movable member 5, together with the internal pressure pᵢ for sampling n from the values for the position z and the speed ż of the movable member 5, the internal pressure pᵢ, the upstream pressure pₐ, the upstream temperature Tₐ, and the opening values dₐ and dₑ of the admission and exhaust valves 10 and 11 for the preceding sampling n−1. Although measured values are not available for the internal pressure pᵢ, the filter algorithm makes it possible to obtain an estimated value \hat{p}ᵢ for this internal pressure, together with estimated values for the position and the speed of the movable member 5, thus making it possible to make a comparison between the predicted state x′ₙ and the measured state yₙ on each sampling n.

The unscented Kalman filter algorithm applies a matrix Qₖ to the three equations of the model, which matrix contains coefficients associated with the confidence given to each equation of the model. Thus, by way of example, for the embodiment shown, the matrix Qₖ may contain the following values:

$${Q}_{k} = [ \begin{matrix}1 & 0 & 0 \\ 0 & 0.01 & 0 \\ 0 & 0 & 0.1\end{matrix} ]$$

The algorithm also applies a matrix Rₖ containing coefficients associated with the confidence in the measured values. It may be observed that since the speed ż of the movable member 5 is measured only indirectly, by differentiating the position measurement z, it is possible to give greater confidence to the model than to the measurement of this magnitude. Thus, in the embodiment shown, the matrix Rₖ may contain the following values, for example:

$${R}_{k} = [ \begin{matrix}1 & 0 \\ 0 & 0.5\end{matrix} ]$$

Furthermore, the unscented Kalman filter algorithm applies coefficients referred to as α [alpha], β [beta], and λ [lambda] that may take the following values respectively in the embodiment shown: 0.65, 2, and 0.

The control unit 15 has three feedback loops for comparing values estimated by the state observer 27 with respective position, force, and mass setpoints so as to be able to calculate corresponding errors. In a first feedback loop 28, referred to as a position loop, a first comparator 29 is arranged to compare the position setpoint z_{c} received via the input 25 with the estimated position \hat{z} as estimated by the state observer 27, in order to calculate their difference which constitutes the position error Δz. This first feedback loop 28 also includes, downstream from the comparator 29, a proportional integral regulator 30 with means for preventing runaway of the integral in order to generate a force setpoint F_{c} from the position error Δz.

In a second feedback loop 31, a second comparator 32 is arranged to compare the force setpoint F_{c} with a force \hat{F} that is estimated to be exerted by the actuator 6 on the movable member 5 in order to calculate a force error ΔF, which is the difference between the force setpoint F_{c} and the estimated force \hat{F}. In order to generate a signal corresponding to the estimated force \hat{F}, the second feedback loop 31 also includes a proportional regulator 33 between the state observer 27 and the second comparator 32, which proportional regulator 33 has gain corresponding to the pneumatic actuation surface area Sᵢ. Thus, by means of this proportional regulator 33, the estimated force \hat{F} is calculated from the estimated internal pressure \hat{p}ᵢ that as estimated by the state observer 27. This second loop also includes, downstream from the second comparator 32, a proportional integral regulator 34 for using the force error ΔF to obtain a command p_{ic} for the internal pressure in the actuator 6, and a calculation module 35 for using this pressure command p_{ic}, the upstream temperature Tₐ, the average cross-section Sᵢₘ of the internal chamber 7 of the actuator 6, the length z₀ of the internal chamber 7 in the neutral position of the actuator 6, and the estimated position \hat{z} of the actuator 6 relative to the neutral position to calculate a mass setpoint m_{c} for the gas contained in the internal chamber, by applying the perfect gas equation as follows:

$${m}_{c} = \frac{{p}_{ic} \cdot {S}_{im} \cdot ( {z}_{0} + \hat{z} ) \cdot {M}_{mol}}{R \cdot {T}_{a}}$$

In a third feedback loop 36, a third comparator 37 is arranged to compare this mass setpoint m_{c} with an estimated mass \hat{m} in order to calculate a mass error Δm, which is the difference between the setpoint mass m_{c} and the estimated mass \hat{m}. This third feedback loop 36 also includes, between the state observer 27 and the comparator 37, a calculation module 38 for calculating the estimated mass \hat{m} from the estimated internal pressure \hat{p}ᵢ, the upstream temperature Tₐ, the average cross-section Sᵢₘ of the internal chamber 7 of the actuator 6, the length z₀ of the internal chamber 7 in the neutral position of the actuator 6, and the estimated position \hat{z} of the actuator 6, by applying the perfect gas equation as follows:

$$\hat{m} = \frac{{\hat{p}}_{ic} \cdot {S}_{im} \cdot ( {z}_{0} + \hat{z} ) \cdot {M}_{mol}}{R \cdot {T}_{a}}$$

Downstream from the comparator 37, this third feedback loop 36 also contains a proportional regulator 39 for applying a gain Kₚ to the signal corresponding to the mass error Δm so as to generate a signal corresponding to a flow rate difference setpoint Δq between the admission duct 8 and the exhaust duct 9. Finally, downstream from the proportional regulator 39, the third feedback loop 36 also has another calculation module 40 configured to calculate a value for the shared-domain regulation signal α_{c} [alpha_c] from the flow rate difference setpoint Δq, on the basis of the following equation:

$${α}_{c} = \frac{Δ q \cdot K + {cd}_{e} \cdot {\hat{p}}_{i}}{{cd}_{a} \cdot {p}_{a} + {cd}_{e} \cdot {\hat{p}}_{i}}$$

where the values cdₐ and cdₑ correspond to the speeds of sound in the gas, respectively in the admission duct 8 and in the exhaust duct 9, and the coefficient K may be expressed using the following equation:

$$K = \frac{{C}^{*}}{{k}_{p} \cdot {k}_{ae} \cdot {k}_{umax}}$$

Thus, in operation, the control unit 15 receives a setpoint signal z_{c} for the position of the movable member, together with signals corresponding to the upstream pressure and temperature measurements pₐ, Tₐ of the gas and the measurement of the position z of the movable member 5, together with the opening values dₐ, dₑ of the admission and exhaust valves 10 and 11. From these measurements of the upstream pressure and temperature pₐ, Tₐ, and of the position z and of the speed ż of the movable member 5, and from the opening values dₐ, dₑ of the admission and exhaust valves 10 and 11, the state observer 27 estimates the current state of the regulator valve 1, including at least the estimated internal pressure \hat{p}ᵢ of the gas in the internal chamber 7 of the actuator, and an estimated position \hat{z} of the movable member 5.

In the first feedback loop 28, the position setpoint z_{c} is compared with the estimated position \hat{z} so as to calculate the position error Δz from which the force setpoint F_{c} is obtained via the proportional integral regulator 30 with means for preventing runaway of the integral.

In the second feedback loop 31, the force setpoint F_{c} is compared with the estimated force \hat{F} calculated from the estimated internal pressure \hat{p}ᵢ as estimated by the state observer 27, so as to calculate the force error ΔF, from which the gas mass setpoint m_{c} is obtained via the proportional integral regulator 34 and the calculation module 35.

In the third feedback loop 36, the mass setpoint m_{c} with the estimated mass \hat{m}, from the estimated internal pressure \hat{p}ᵢ as estimated by the state observer 27, so as to calculate the mass error Δm, from which the proportional regulator 39 and the calculation module 40 obtain the shared-domain regulation command α_{c} [alpha_c] for the admission and exhaust valves 10 and 11.

The control unit 15, which is in the form of a digital regulator, thus constitutes a discrete system in which execution of each of the feedback loops 28, 31, and 36 is repeated at a corresponding frequency. In order to obtain a better response, the frequency of the third loop 36 may be significantly higher than the frequency of the second loop 31, which in turn may be higher than the frequency of the first loop 28. Thus, by way of example, the third loop 36 may have a frequency that is ten times higher than the second loop 31, which in turn may have a frequency that is ten times higher the frequency of the first loop 31.

Finally, on the basis of the shared-domain regulation command α_{c} [alpha_c], the separator circuit 22 generates the individual commands uₐ and uₑ respectively for the admission valve 10 and for the exhaust valve 11 so as to control the actuator 6 of the regulator valve 1, and does so in continuous manner.

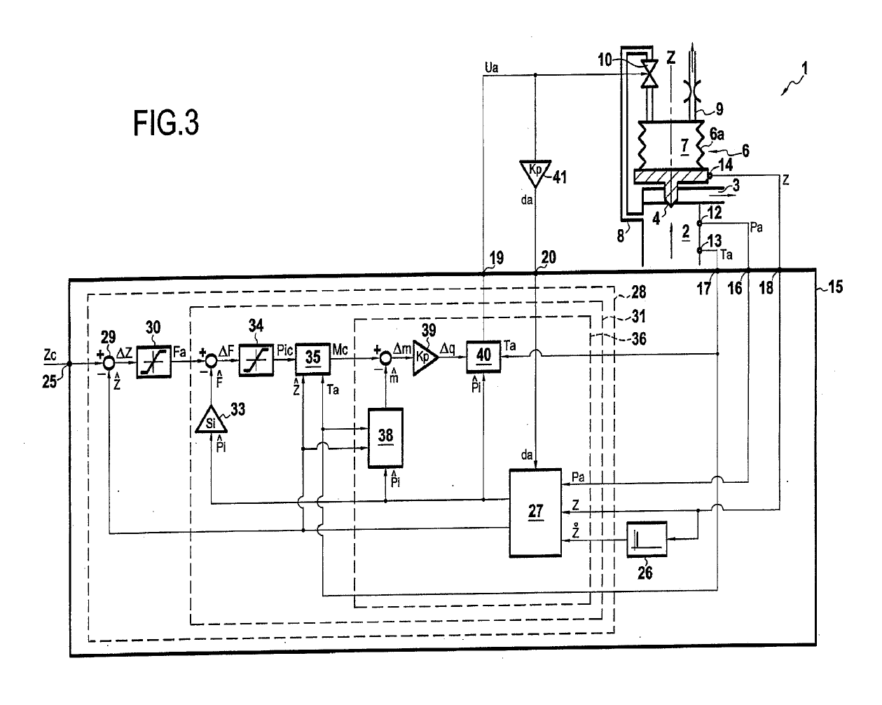

Although in this embodiment the regulator valve 1 has an admission valve 10 and an exhaust valve 11 for controlling the actuator 6, it is also possible to envisage using only one admission or exhaust valve. Thus, in the embodiment shown in FIG. 3, the exhaust valve is replaced by a choked nozzle with a constant opening value dₑ, and it is only the admission valve 10 that is controlled by the control unit 15. A separator circuit is therefore not needed, and the calculation module 40 is configured to obtain the control signal uₐ directly from the flow rate difference setpoint Δq, on the basis of the following equation:

$${u}_{a} = \frac{{k}_{ae} \cdot {d}_{e} \cdot {cd}_{e} \cdot {\hat{p}}_{i} + Δ q \cdot {C}^{*}}{{k}_{ae} \cdot {k}_{p} \cdot {cd}_{a} \cdot {p}_{a}}$$

Furthermore, since the opening of the exhaust valve 9 is constant, there is no need to deliver a signal giving an opening value for the exhaust duct 9. The state observer 27 may use a constant opening value dₑ in order to estimate of the dynamic system formed by the regulator valve 1.

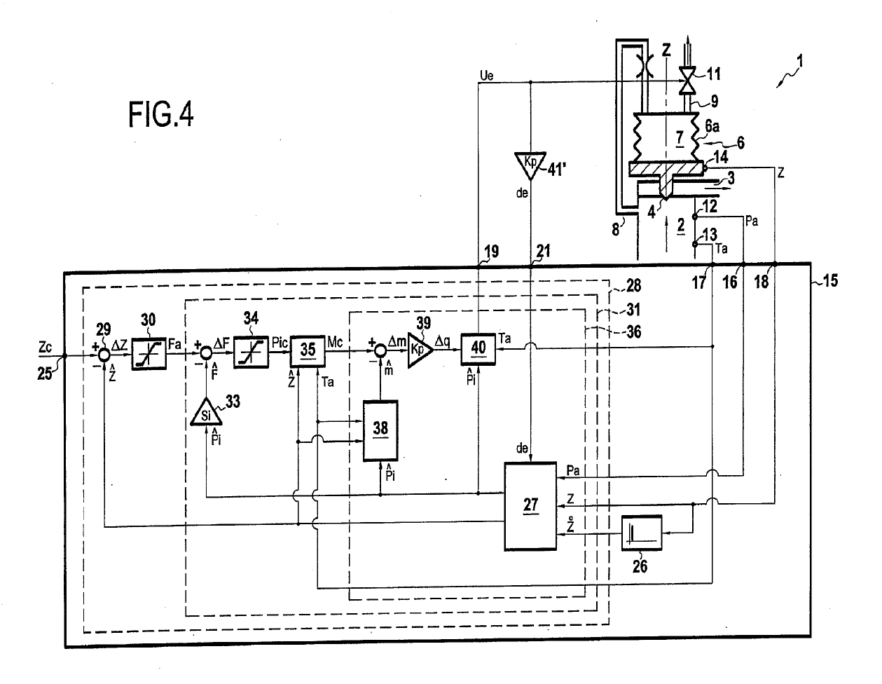

Alternatively, in the embodiment shown in FIG. 4, the exhaust valve is replaced by a choked nozzle with a constant opening value dₑ, and only the admission valve 11 is controlled by the control unit 15. A separator circuit is thus no longer necessary, and the calculation module 40 is configured to obtain the control signal uₑ directly from the flow rate difference setpoint Δq on the basis of the following equation:

$${u}_{e} = \frac{{k}_{ae} \cdot {d}_{a} \cdot {cd}_{a} \cdot {p}_{a} - Δ q \cdot {C}^{*}}{{k}_{ae} \cdot {k}_{p} \cdot {cd}_{e} \cdot {\hat{p}}_{i}}$$

Furthermore, since the opening of the admission duct 8 is constant, there is no need to return a signal giving an opening value for the exhaust duct 8. The state observer 27 can use a constant opening value dₑ to estimate the state of the dynamic system formed by the regulator valve 1.

Although the present invention is described with reference to specific embodiments, it is clear that various modifications and changes can be undertaken on those embodiments without leaving the general scope of the invention as defined by the claims. Furthermore, individual characteristics of the various embodiments mentioned may be combined in additional embodiments. Consequently, the description and the drawings should be considered in a sense that is illustrative rather than restrictive.

1-14. (canceled)

15. A regulator valve for regulating a flow of gas from an upstream duct to a downstream duct, the regulator valve comprising:
a passage suitable for bringing the upstream duct into communication with the downstream duct;
a movable member arranged so as to vary a flow section of said passage by moving;
an actuator with an internal chamber in communication with an exhaust duct and an admission duct suitable for being connected to the upstream duct, the actuator being arranged in such a manner as to move the movable member according to a pressure in the internal chamber;
at least one valve installed in the admission duct or in the exhaust duct;
an upstream pressure sensor suitable for being installed in the upstream duct;
a sensor for sensing the position of the movable member; and
a control unit connected to at least the upstream pressure sensor and the sensor for sensing the position of the movable member, and to each valve installed in said admission duct or said exhaust duct, the control unit incorporating at least one state observer suitable for estimating at least one pressure that exists in the internal chamber from measurements of the position of the movable member and of the upstream pressure, and from an opening value for each valve installed in the admission duct or the exhaust duct.

16. The regulator valve according to claim 15, wherein the state observer is a state observer using an unscented Kalman filter algorithm.

17. The regulator valve according to claim 15, further comprising:
an admission valve installed in the admission duct and an exhaust valve installed in the exhaust duct.

18. The regulator valve according to claim 15, wherein each valve installed in the admission circuit or the exhaust circuit is electrically controlled.

19. The regulator valve according to claim 15, wherein the actuator includes a resilient member for opposing a resilient return force against the pressure that exists in the internal chamber.

20. A method of regulating a flow of gas from an upstream duct to a downstream duct with the regulator valve according to claim 15, the method comprising at least the following steps:
obtaining a measurement of the position of the movable member by using the position sensor;
obtaining a measurement of the pressure in the upstream duct by using the pressure sensor;
obtaining an opening value for each valve installed in the admission duct or the exhaust duct of the actuator;
obtaining a force setpoint for the actuator;
using the state observer to estimate at least one pressure existing in the internal chamber from the measured position of the movable member and the measured pressure, and from the opening value of each valve;
using the pressure estimated to exist in the internal chamber to calculate a force estimated to be exerted by the actuator;
calculating a force error, which is a difference between the force estimated to be exerted by the actuator and the force setpoint for the actuator; and
using the force error to obtain a command for each valve installed in the admission duct or the exhaust duct of the actuator.

21. The method according to claim 20, further comprising the following steps:
obtaining a position setpoint for the movable member; and
calculating a position error of the movable member; and wherein the force setpoint for the actuator is obtained from the position error of the movable member.

22. The method according to claim 21, wherein said force setpoint is obtained as a function of the position error by a proportional integral regulator with means for preventing integral runaway.

23. The method according to claim 21, wherein the position error of the movable member is a difference between an estimated position of the movable member and the position setpoint.

24. The method according to claim 20, wherein the command for each valve is obtained as a function of a mass setpoint for gas in the internal chamber, which is calculated on the basis of the force error.

25. The method according to claim 24, wherein the mass setpoint is calculated as a function of a setpoint for pressure in said internal chamber, which setpoint is obtained from the force error.

26. The method according to claim 25, wherein the mass setpoint is calculated by applying the ideal gas equation to the pressure setpoint, with a volume of the internal chamber and a gas temperature.

27. The method according to claim 24, wherein the mass setpoint is compared with an estimated mass for gas in the internal chamber in order to calculate a mass error, which is a difference between the mass setpoint and the estimated mass.

28. The method according to claim 27, wherein a setpoint for the difference between the admission flow rate and the exhaust flow rate is obtained on the basis of the mass error, and the command for each valve installed in the admission duct or the exhaust duct is calculated using the inverse of a non-linear function determining the difference between the admission flow rate and the exhaust flow rate on the basis of an opening value for each valve installed in the admission duct or the exhaust duct of the actuator.
